(19) United States
(12) Patent Application Publication
(10) Pub. No.: US 2011/0199674 A1
(43) Pub. Date: Aug. 18, 2011

(54) LAMINATE THAT SCREENS INFRARED RADIATION, IS TRANSPARENT TO VISIBLE LIGHT, AND HAS AN OPTICAL WINDOW THAT ALLOWS INFRARED LIGHT TO PASS, METHOD FOR THE PRODUCTION THEREOF, AND USE THEREOF

(76) Inventors: Martin Melcher, Herzogenrath (DE); Stefan Droste, Herzogenrath (DE); Dirk Wohlfeil, Raeren (BE); Florian Manz, Aachen (DE); Volkmar Offermann, Eschweiler (DE); Uwe Van Der Meulen, Nideggen (DE)

(21) Appl. No.: 13/126,749

(22) PCT Filed: Jan. 18, 2010
(86) PCT No.: PCT/EP10/50507

§ 371 Date: Apr. 28, 2011

(30) Foreign Application Priority Data
Jan. 24, 2009 (DE) 10 2009 006 062.6
Apr. 30, 2009 (DE) 10 2009 019 622.6

(51) Int. Cl. G02B 5/20; B32B 37/00; B32B 38/04

(52) U.S. Cl. 359/359; 156/60; 156/256

(57) ABSTRACT

A laminate adapted to filter out infrared radiation, yet transparent to visible light. The laminate further comprises an optical window that is permeable to infrared radiation. A method of manufacturing the laminate is also described.

The present invention relates to a new, infrared-radiation-screening laminate transparent to visible light with an optical window permeable to infrared radiation.

The present invention also relates to a new method for the production of an infrared-radiation-screening laminate transparent to visible light.

And finally, the present invention relates to the new use of the new, infrared-radiation-screening laminate transparent to visible light as well as the colored infrared-radiation-screening laminate transparent to visible light.

Modern laminated safety glass panes, in particular, windshields for motor vehicles, have an infrared-radiation-screening effect to prevent overheating of the interior. On the other hand, sensors and cameras that are sensitive to infrared radiation, such as sensors for distance measuring or night vision devices, are increasingly used in motor vehicles. Their function is, however, greatly impaired or rendered completely inoperative by the infrared-radiation-screening effect of the laminated safety glass panes.

In the case of laminated safety glass panes based on colored glasses, such as green glass that contains chromium dioxide or brown glass that contains iron sulfides, this problem is particularly serious, because the glasses are not tinted merely for aesthetic reasons, but also to cause or intensify the infrared-radiation-screening effect. However, these colored glasses cannot be locally decolorized to create an optical window permeable to infrared radiation.

From the European patent application EP 1 857 424 A1, a colored, infrared-radiation-screening laminate transparent to visible light is known that contains or is made of a first colorless glass pane, an intermediate layer, and a second colorless glass pane. The intermediate layer contains a polyvinyl acetal resin as a layer-forming material, an infrared-radiation-absorbing material, and a tinting material. This known laminate can certainly be used instead of laminated safety glass panes based on colored glasses; however, it is unable to solve the above-described problem that is caused by the infrared-radiation-screening effect.

The object of the present invention is to provide new, optionally colored, infrared-radiation-screening laminates transparent to visible light that remedy the disadvantages of the prior art and, despite their infrared-radiation-screening effect, do not impair the function of sensors and cameras sensitive to infrared irradiation. Moreover, the new laminates should have high weathering stability, intermediate layer adhesion, penetration resistance, and breakage resistance as well as, optionally, color stability and high residual strength after damage.

A further object of the present invention is to provide a new method for the production of optionally colored, infrared-radiation-screening laminates that remedies the disadvantages of the prior art but which, in a simple and very readily reproducible manner, delivers laminates in high quantities that, despite their infrared-radiation-screening effect, do not impair the function of sensors and cameras sensitive to infrared radiation as well as having high weathering stability, intermediate layer adhesion, penetration resistance, and breakage resistance as well as, optionally, color stability and high residual strength after damage.

And finally, an object of the present invention is to provide a new use for the new, optionally colored, infrared-radiation-screening laminates transparent to visible light as well as for the, optionally colored, infrared-radiation-screening laminates transparent to visible light in means of transportation for land, water, and air traffic as well as in the furniture, equipment, and construction sector.

Accordingly, the new, colored, infrared-radiation-screening laminate transparent to visible light was found, that comprises at least
(A) a first colorless, clear, transparent layer,
(B) on the first colorless, clear, transparent layer, an intermediate layer transparent to visible light and with an infrared-radiation-screening effect (b11), comprising
   (b1) at least one polyvinyl acetal resin as a layer-forming material and
   (b2) at least one optical window permeable to at least infrared radiation, and
(C) on the intermediate layer, a second colorless, clear, transparent layer,
   stacked in the sequence specified, wherein the laminate (ABC) has a g-value <75% outside the optical window (b2) permeable to infrared radiation.

In the following, the new, infrared-radiation-screening laminate transparent to visible light is referred to as “laminate according to the invention”.

Also found was the new method for production of an infrared-radiation-screening laminate transparent to visible light, wherein
(I) a precursor of the intermediate layer (B) transparent to visible light and with an infrared-radiation-screening effect (b11), comprising at least one polyvinyl acetal resin as a layer-forming material (b1), is produced, and
(II) in it, at least one optical window (b2) permeable to infrared radiation is created, after which
(III) the resulting intermediate layer (B) is firmly bonded to at least one optical window (b2) permeable to infrared radiation with two clear, transparent layers (A) and (C) such that a laminate results, wherein the layers (A), (B), and (C) are stacked in the sequence specified.

In the following, the new method for production of an infrared-radiation-screening laminate transparent to visible light is referred to as “method according to the invention”.

And finally, the new use of the laminate according to the invention and of the laminate produced according to the method according to the invention in means of transportation for land, water, and air traffic as well as in the furniture, equipment, or construction sector was found, which is referred to in the following as “use according to the invention”.

With regard to the prior art, it was surprising and not inferable for the person skilled in the art that the object of the present invention could be accomplished using the laminate according to the invention, the method according to the invention, and the use according to the invention.

In particular, it was surprising that the laminates according to the invention no longer have the disadvantages of the prior art, but rather, despite their infrared-radiation-screening effect, do not impair the function of sensors and cameras sensitive to infrared radiation. Also, the new laminates have high weathering stability, intermediate layer adhesion, penetration resistance, and breakage resistance as well as, optionally, color stability and high residual strength after damage

Moreover, it was surprising that the method according to the invention no longer had the disadvantages of the prior art, but rather, in a simple and very readily reproducible manner, delivered laminates in high quantities that, despite their infrared-radiation-screening effect, did not impair the function of sensors and cameras sensitive to infrared radiation, had high weathering stability, intermediate layer adhesion, penetration resistance, and breakage resistance as well as, optionally, color stability and high residual strength after damage.

And finally, it was surprising that the laminates according to the invention and the laminates produced according to the method according to the invention could be used outstandingly in means of transportation for land, water, and air traffic as well as in the construction sector, where, despite their infrared-radiation-screening effect, they did not impair the function of sensors and cameras sensitive to infrared radiation, had high weathering stability, color stability, intermediate layer adhesion, penetration resistance, and breakage resistance and high residual strength after damage.

The laminates according to the invention have an infrared-radiation-screening effect. This effect can be caused by absorption or reflection of the infrared radiation. Preferably, it is caused by absorption. Preferably, more than 50%, in particular more than 70%, of the incident infrared radiation is absorbed.

Sensors and cameras for infrared radiation are preferably sensitive in the range from 350 nm to 15 μm, more preferably from 380 nm to 2200 nm, and particularly preferably from 400 nm to 1200 nm.

“g-value” means according to ISO 9050:2003-08 total transmittance of solar energy through the laminate according to the invention of a glazing. The g-value of a glazing is calculated from the directly transmitted sunlight and the infrared light secondarily radiated into the interior by the laminate.

The g-value is preferably <75%, more preferably <70%, and particularly preferably <64%, outside the optical window (b2) of the laminate according to the invention.

The laminates according to the invention can be colored. In the context of the present invention, this means that they can have a chromatic color or a nonchromatic color, but, in particular, a chromatic color.

The laminates according to the invention are transparent to visible light. Preferably, they have a transparent light transmission of >50%, more preferably >60%, and, in particular, >70%.

The laminates according to the invention can have different three-dimensional shapes. Thus, they can be planar or more or less sharply bent or curved in one or a plurality of spatial directions.

The area of the laminates can vary broadly and is determined by the respective purpose for use in the context of the use according to the invention. Thus, they can have an area of a few square centimeters up to several square meters. In particular, they have an area like windshields, side windows, rear windows, or glass roofs for motor vehicles commonly have.

The thickness of the laminates according to the invention can vary broadly and, thus, be eminently adapted to the requirements of the individual case. Preferably, the thicknesses are from 4 to 60 mm.

The laminates according to the invention include a first and a second colorless, clear, transparent layer (A) and (C).

“Clear” means that the layers (A) and (C) have cloudiness or haze detectable only by instruments or none at all.

Here, “transparent” means that the layers (A) and (C) have a visible light transmission of >70%, more preferably >80%, and in particular >90%.

As materials for the construction of the layers (A) and (C), basically, all materials that have the above-described profile of properties and are stable and not damaged under the conditions of production and use of the laminates according to the invention come into consideration.

Preferably, glass and clear plastics, preferably rigid, clear plastics, in particular polystyrene, polyamide, polyester, polyvinyl chloride, polycarbonate, or polymethyl methacrylate, are used.

Glass is more preferably used. Basically, all glasses as are used for the production of the laminated glasses, in particular of laminated safety glasses, come into consideration. Preferably, float glass and prestressed and partially prestressed float glass are used.

Float glass is a sheet glass that is produced using the float glass method. Both methods for the production of float glass and the precise meaning of this term are known to the person skilled in the art and need not be further presented here. Partially prestressed and prestressed float glass are commonly used for the production of single-pane safety glass. In particular, alkali-lime hard glass or soda lime glass according to DIN EN 572-1 are used. Further examples of suitable glasses are described in Römpp-Online 2008 under the keywords “Glas [glass]”, “Hartglas [hard glass]”, or “Sicherheitsglas [safety glass]” or are known from the German translation of the European patent EP 0 847 965 B1 with the file number DE 697 31 2 168 T2, page 8, par. [0053].

The thickness of the layers (A) and (C) can vary broadly and, thus, be eminently adapted to the requirements of the individual case. Preferably, glasses with standard glass thicknesses of 2, 3, 4, 5, 6, 8, 10, 12, 15, 19, and 25 mm are used.

The area of the layers (A) and (C) can vary broadly and is determined by the area of the laminates according to the invention that contain them. Accordingly, the above-described areas are preferably used.

The laminate according to the invention also includes an optionally colored, infrared-radiation-screening intermediate layer (B) transparent to visible light. Here, the properties “colored”, “infrared-radiation-screening”, and “transparent to visible light” have the respective meanings specified above.

The intermediate layer (B) includes at least one polyvinyl acetal resin (b1) as a layer-forming material. Examples of suitable polyvinyl acetal resins (b1) are known from the European patent application EP 1 857 424 A1, page 3, par. [0012], through page 4, par. [0020].

The polyvinyl acetal resin (b1) content of the intermediate layer (B) can vary quite broadly and, thus, be eminently adapted to the requirements of the individual case. It is essential that the content not be set so low that the amount of polyvinyl acetal resin (b1) is no longer adequate for the formation of a homogeneous, continuous layer. Preferably, the content, in each case relative to the intermediate layer (B), is 50 to 99.998 wt.-%, more preferably, 55 to 99.9 wt.-%, and in particular, 60 to 99 wt.-%.

The intermediate layer (B) has an infrared-radiation-screening effect (b11) as well as, optionally, a tinting effect (b12). In particular, the intermediate layer (B) has an infrared-radiation-screening effect (b11) and tinting effect (b12).

The infrared-radiation-screening effect (b11) as well as the infrared-radiation-screening effect (b11) and the tinting effect (b12) can be adjusted in quite different ways.

The infrared-radiation-screening effect (b11) can be adjusted using at least one infrared-radiation-screening material (b11).

Basically, all common and known infrared-radiation-screening materials (b11) that are stable under the conditions of the production and the use of the laminates according to the invention come into consideration.

The infrared-radiation-screening materials (b11) can be present in the intermediate layer (B) in fine particulate or molecularly dispersed form; preferably, they are present as fine particulate. Preferably, they have particle sizes in the range from 10 nm to 50 μm, more preferably, 20 nm to 25 μm, and in particular, 30 nm to 10 μm.

Preferably, the infrared-radiation-screening material (b11) is selected as fine particulate metals, metal oxides, -hydroxides, -nitrides, -oxynitrides, -sulfides, -phosphates, -pyrophosphates, -metaphosphates, -polyphosphates, -silicates, -titanates, -vanadates, -molybdates, -tungstates, and -fluorides, transparent electrically conductive oxides, TCO, and infrared-radiation-absorbing organic pigments or mixtures thereof.

Examples of suitable infrared-radiation-screening materials (b11) are known from the European patent applications EP 1 857 424 A1, page 4, par. [0021] through [0022], and EP 1 790 701 A1, page 5, par. [0036], through page 6, par. [0047], or the translation of the European patent EP 0 523 959 B1 with the file number DE 692 30 121 T2, page 7, line 25, through page 15, line 8, and page 18, line 11, through page 62, line 5.

The infrared-radiation-screening material (b11) content of the intermediate layer (B) can vary broadly and, thus, be eminently adapted to the requirements of the individual case. Preferably, the intermediate layer (B) contains, in each case based on its total amount, 0.001 to 20 wt.-%, more preferably, 0.01 to 15 wt.-%, and in particular, 0.1 to 10 wt.-% of the material (b11).

The additional, tinting effect (b12) can be adjusted in quite different ways.

Thus, both effects (b11) and (b12) can be adjusted using at least one material that combines both effects (b11) and (b12) therein. Basically, all common and known materials (b11/b12) that are stable under the conditions of the production and the use of the laminates according to the invention come into consideration.

If materials (b11/b12) are used, generally speaking, no additional infrared-radiation-screening materials (b11) and/or tinting materials (b12) have to be used.

The materials (b11/b12) can be present in the intermediate layer (B) in fine particulate or molecularly dispersed form; preferably, they are present as fine particulate. Preferably, they have particle sizes in the range from 10 nm to 50 μm, more preferably, 20 nm to 25 μm, and in particular, 30 nm to 10 μm.

Examples of suitable materials (b11/b12) are tinting and infrared-radiation-screening iron oxide pigments, as are described, for example, in Römpp Online 2008 under the keyword “Eisenoxid-Pigmente [iron oxide pigments]”. Iron sulfide pigments and iron- and chromium-containing pigments also come into consideration.

The materials (b11/b12) content of the intermediate layer (B) can vary quite broadly and, thus, be eminently adapted to the requirements of the individual case. Preferably, the intermediate layer (B) contains, in each case based on its total amount, 0.001 to 30 wt.-%, more preferably, 0.01 to 20 wt.-%, and in particular, 0.1 to 10 wt.-% of a material (b11/b12).

The additional tinting effect (b12) can, however, also be produced using a tinting material (b12) that is used in addition to the obligatory infrared-radiation-screening material (b11) and/or (b11/b12), in particular (b11).

Basically, all common and known tinting materials (b12) that are stable under the conditions of the production and the use of the laminates according to the invention come into consideration. Preferably, the tinting materials (b12) are selected from the group consisting of inorganic pigments as well as organic pigments and dyes.

The inorganic and organic pigments (b12) can be present as fine particulates. The organic dyes (b12) can be present in molecularly dispersed form.

Examples of suitable inorganic pigments (b12) are known from Römpp Online 2008, “Anorganische Pigmente [inorganic pigments]”, “Anorganische Buntpigmente [inorganic chromatic pigments]”, “Eisenoxid-Pigmente [iron oxide pigments]”, or “Chromoxid(grün)-Pigmente [chromium oxide (green) pigments]”.

Examples of suitable organic pigments (b12) and dyes (b12) are azo, metal complex, isoindolinone, isoindoline, phthaloycyanine, quinacridone, perinone, perylene, anthraquinone, acridine, diketopyrrolo, thioindigo, dioxazine, triphenylmethane, and quinonaphthalone pigments and dyes.

Particularly preferably, green pigments (b12) and dyes (b12) are used.

The tinting materials (b12) content of the intermediate layer (B) can vary quite broadly and, thus, be eminently adapted to the requirements of the individual case. Preferably, the intermediate layer (B) contains, in each case based on its total amount, 0.001 to 30 30 wt.-%, more preferably, 0.01 to 20 wt.-%, and in particular, 0.1 to 10 wt.-% of a material (b12).

Obviously, combinations of at least one of the above-described materials (b11/b12) and at least one of the above-described materials (b11) and/or at least one of the above-described materials (b12) can be used. For this, the above-described preferred amounts can be used in each case.

Moreover, the intermediate layer (B) can contain common and known additives (b3) in effective amounts. The additives (b3) have no or only a very slight infrared-radiation-screening effect. Examples of suitable additives are known from the European patent application EP 1 857 424 A1, page 3, par. [0010] and [0011], and page 4, par. [0027], through page 5, par. [0037].

The intermediate layer (B) can be constructed in quite different ways.

Thus, in a first embodiment of the intermediate layer (B), the materials (b11) and/or (b11/b12) as well as (b12) can be distributed homogeneously in one layer of polyvinyl acetal resin (b1).

Polyvinyl acetal includes acetal groups with 1 to 2 C-atoms, preferably 1 to 8, in particular, 2 to 6 C-atoms. Here, polyvinyl butyral is particularly preferred.

In a second embodiment of the intermediate layer (B), the material (b11) or the material (b11/b12) can be predominantly present, i.e., as more than 50% of its total amount in a layer made of polyvinyl acetal resin (b1), with the remaining amount present in a separate layer or in two separate layers on one or both primary surfaces of the layer made of polyvinyl acetal resin (b1). Correspondingly, the materials (b11) and/or (b12) can be predominantly present, i.e., as more than 50% of their total amount, in a layer made of polyvinyl acetal resin (b1). The remaining amount of the materials (b11) and (b12) can then be present on one or on two primary surfaces of the layer made of polyvinyl acetal resin (b1). Here, the materials (b11) and (b12) can together form a homogeneous layer or be included in a homogeneous layer or they can form a separate homogeneous layer or be included in separate homogeneous layers.

In a third embodiment of the intermediate layer (B), the material (b11) or (b12) can be distributed homogeneously in a layer made of polyvinyl acetal resin (b1), with the respective other material (b11) or (b12) then present on one or both primary surfaces of the layer made of polyvinyl acetal resin (b1) as a homogeneous layer or in a homogeneous layer.

A fourth embodiment of the intermediate layer (B) corresponds to the third embodiment, only a lesser amount, i.e., less than 50% of the respective total amount, of the material (b11) or (b12) in addition to the total amount or the predominant amount of the respective other material (b11) or (b12) can be distributed in the layer made of polyvinyl acetal resin (b1).

In a fifth embodiment of the intermediate layer (B), the total amount of the material (b11), of the material (b11/b12) or the materials (b11) and/or (b11/b12) as well as (b12) can be present as a homogeneous layer or in a homogeneous layer on one primary surface or both primary surfaces of a layer made of polyvinyl acetal resin (b1).

In a sixth embodiment of the intermediate layer (B), the total amount of the material (b11) can be present as a homogeneous layer or in a homogeneous layer on one primary surface and the total amount of the material (b12) can be present as a homogeneous layer or in a homogeneous layer on the other primary surface of a layer made of polyvinyl acetal resin (b1).

The above list is not definitive, but rather the person skilled in the art can, using the teaching according to the invention, readily find additional embodiments of the intermediate layer (B).

The thickness of the intermediate layer (B) can vary broadly and, thus, be eminently adapted to the requirements of the individual case. Preferably, the thickness is from 100 μm to 5 mm, more preferably, 200 μm to 3 mm, and in particular, 200 μm to 2 mm.

The area of the intermediate layer (B) preferably corresponds to the area of the laminate according to the invention.

For the laminate according to the invention, it is essential that the intermediate layer (B) have at least one, in particular one optical window (b2) permeable to infrared radiation.

“Permeable” means that the optical window (b2) has a transmission for infrared radiation that is significantly higher than the transmission for infrared radiation in the regions of the laminate according to the invention outside the optical window (b2). Preferably, the transmission for infrared radiation is >40%, more preferably >50%, and in particular, >60%.

The area, shape, and placement of the optical window (b2) permeable to infrared irradiation in the laminate according to the invention can vary broadly and be eminently adapted to the requirements of the individual case.

Thus, the area of the optical window (b2) may not be so large that the infrared-radiation-screening function of the laminate according to the invention is impaired. Preferably, the area of the optical window (b2) occupies not more than 30%, more preferably, not more than 20%, and in particular, not more than 10% of the area of the laminate according to the invention. The lower limit for the area of the optical window (b2) is determined by the respective purpose for use, in particular, by the requirements of the sensors and cameras sensitive to infrared radiation that are placed behind the optical window (b2).

The shape of the optical window (b2) is likewise determined by the respective purpose for use. Preferably, the shape is circular, elliptical, rectangular, square, rhomboid, trapezoid, or triangular.

The placement of the optical window (b2) is also determined by the respective purpose for use. Preferably, it is placed such that, on the one hand, it lies in the beam path of the sensors and cameras sensitive to infrared radiation; and, on the other hand, it does not interfere with other functions, such as would be the case with placement directly in the field of vision of the driver of a motor vehicle.

In a first embodiment, the optical window (b2) is formed by at least one, in particular one, precisely fitting insert (b21), that is made substantially or entirely of polyvinyl acetal resin (b1) in at least one, in particular one, opening (b22).

In this first embodiment of the laminate according to the invention, the shape, area, and placement of the insert (b21) determine the shape, area and placement of the optical window (b2).

In a second embodiment, the optical window (b2) is present in at least one layer that contains or is made of the materials (b11), the materials (b11/b12) or the materials (b11) and/or (b11/b12) as well as (b12) and covers a layer (b1) made substantially or entirely of polyvinyl acetal resin, in particular covers the entire surface. The optical window (b2) is formed by a recess in the layer that contains or is made of the materials (b11), the materials (b11/b12) or the materials (b11) and/or (b11/b12) as well as (b12).

With regard to area, shape, and placement of the optical window (b2) according to the second embodiment, what has been stated above in this regard applies analogously.

The second embodiment of the optical window (b2) is preferably used in the above-described fifth and sixth embodiments of the intermediate layer (B).

The first and second embodiment of the optical window (b2) can be combined with each other in a suitable manner, with the person skilled in the art able to find such combinations implicitly based on the teaching according to the invention.

In particular, the first embodiment of the optical window (b2) is used with the precisely fitted insert (b21) in the opening (b22).

The laminate according to the invention can be produced using different methods. According to the invention, it is advantageous to produce the laminate according to the invention using the method according to the invention.

In the method according to the invention, in the first step of the method, a colored, infrared-radiation-screening precursor to the intermediate layer (B) transparent to visible light is produced.

The precursor of the intermediate layer (B) includes the components (b1), (b11), (b11/b12) or (b11) and/or (b11/b12) as well as (b12) described above in detail. Moreover, the precursor of the intermediate layer (B) can include at least one of the above-described components (b3).

In a first embodiment of the first step of the method, the precursor of the intermediate layer (B) can be produced in that at least one polyvinyl acetal resin (b1) is mixed with at least one material (b11), with at least one material (b11/b12) or with at least one material (b11) and/or at least one material (b11/b12) and at least one material (b12) and the resultant mixture is formed into a film (B). In this process, at least one more additive (b3) can be added.

The mixing of the components can be accomplished using common and known methods and devices in solution, dispersion, or melt. Examples of suitable mix aggregates are agitator vessels, Ultra-Turrax, in-line-dissolvers, kneaders, and extruders. The resulting homogeneous mixture can be formed into the film (B) in a common and known manner, for example, by casting from solution or dispersion, calendering, pressing, or film blowing.

In a second embodiment of the first step of the method, the precursor of the intermediate layer (B) can be produced in that a film (b1) that includes either the material (b11) or the material (b12) and that has, preferably, been produced in the above-described manner, or a film (b1) that is substantially or entirely made of a polyvinyl acetal resin (b1) is provided with at least one layer that contains or is made of at least one material (b11), at least one material (b11/b12) or at least one material (b11) and/or at least one material (b11/b12) as well as at least one material (b12). The relevant layers can be produced from the materials themselves or from liquid or solid mixtures that contain these materials. For the application of these layers, common and known methods for the application of liquids and solids, such as casting from solution or dispersion, spraying, roller application, printing, or powder application, as well as the corresponding apparatuses can be used.

Also, the first and second embodiment of the first step of the method can be suitably combined with each other to obtain intermediate layers (B) of the above-described embodiments as well as other embodiments. The person skilled in the art can implicitly find suitable combinations based on the teaching according to the invention.

In the second step of the method according to the invention, the precursor of the intermediate layer (B) is provided with an optical window (b2) permeable to infrared radiation.

This can be accomplished in that, already at the time of application of the layer or the layers with infrared-radiation-screening effect (b11), the region of the surface of the film (b1) provided for the optical window (b2) is not coated, such that this region remains free of the materials (b11) and (b11/b12) with infrared-radiation-screening effect (b11).

It is, however, also possible to produce the optical window (b2) in that in the precursor of the intermediate layer (B) a corresponding opening (b22) is produced, for example, by punching or cutting out, and a precisely fitting insert (b21) that is substantially or entirely made of polyvinyl acetal resin (b1) is inserted.

Here also, the embodiments of the second step of the method can be suitably combined with each other, with the person skilled in the art able to find additional combinations implicitly based on the teaching according to the invention.

In particular, the optical window (b2) is produced in that a corresponding opening (b22) is produced in the precursor of the intermediate layer (B), for example, by punching or cutting out, and a precisely fitting insert (b21) that is substantially or entirely made of polyvinyl acetal resin (b1) is inserted, since, in this case, no additional coating apparatuses, coating agents, and corresponding steps of the method have to be used.

In the third step of the method according to the invention, the resulting film (B) is firmly bonded with at least one optical window (b2) permeable to infrared radiation with two clear, transparent layers (A) and (C) such that a laminate according to the invention results, in which the layers (A), (B), and (C) are stacked in the sequence specified.

For the third step of the method, common and known methods and apparatuses, such as are described, for example, in the European patent EP 1 857 424 A1, page 5, par. [0042] through [0044], are used.

The resulting laminates according to the invention have an excellent profile of properties from an applications engineering standpoint such that they can be used in many ways. In particular, they are used advantageously in means of transportation for land, water, and air traffic, preferably in motor vehicles, such as automobiles, trucks, and trains, in aircraft and in ships as well as in the furniture, equipment, or construction sector, preferably as transparent components.

Particularly preferably, the laminates according to the invention are used as laminated safety glass panes in means of transportation, in particular windshields, side windows, rear windows, and glass roofs, especially windshields, for motor vehicles, especially automobiles, as well as architectonic components in the construction sector, in particular for overhead glazing for roofs, glass walls, façades, window panes, glass doors, balustrades, railing glass, skylights, or glass that can be walked on.

Because of the optical window (b2) present in the laminates according to the invention and permeable to infrared radiation, sensors or cameras sensitive to infrared radiation placed in front of or behind it can fully perform their function without the infrared-radiation-screening effect of the laminate according to the invention being impaired. In addition, they also have high weathering stability, intermediate layer adhesion, penetration resistance, and breakage resistance as well as, optionally, color stability as well as high residual strength after damage.

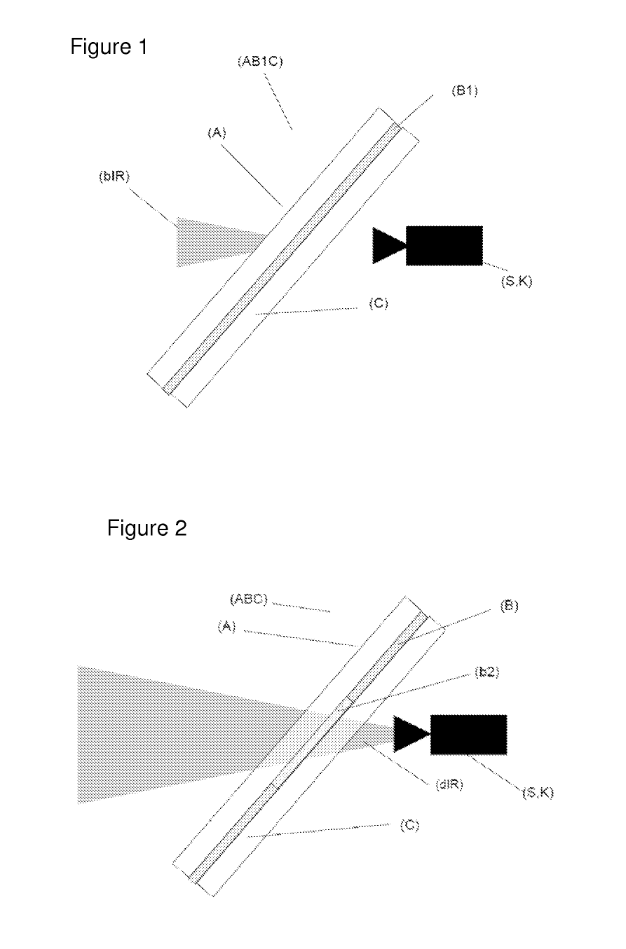

In the following, the laminate according to the invention is explained in greater detail with reference to FIG. 1 through FIG. 3. FIG. 1 through FIG. 3 are schematic depictions intended to illustrate the principle of the invention. The schematic depictions do not, consequently, need to be true to scale. Consequently, the size relationships depicted do not have to correspond to the size relationships used in the exercise of the invention in practice.

FIG. 1 depicts a laminated safety glass pane according to the European patent application EP 1 857 424 A1 in cross-section.

FIG. 2 depicts a laminated safety glass pane according to one embodiment of the present invention in cross-section.

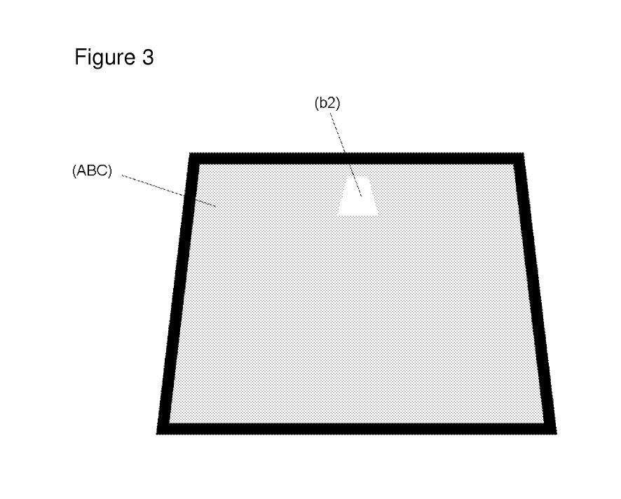

FIG. 3 depicts the top plan view of the laminated safety glass pane according to FIG. 2.

In FIG. 3, the reference characters have the following meaning:
(A) colorless, clear float glass pane,
(B) intermediate layer, containing a green tinting pigment (b12) and indium tin oxide ITO as an infrared-radiation-absorbing pigment (b11), (b2) optical window made of pure polyvinyl butyral permeable to infrared radiation,
(B1) polyvinyl butyral film, containing a green tinting pigment (b12) and indium tin oxide ITO as an infrared-radiation-absorbing pigment (b11) without an optical window (b2) permeable to infrared radiation,
(C) colorless, clear float glass pane,
(ABC) laminate with an optical window permeable to infrared radiation (b2),
(AB1C) laminate without an optical window (b2) permeable to infrared radiation,
(bIR) blocked infrared radiation,
(dIR) permeating infrared radiation, and
(S,K) sensor or camera sensitive to infrared radiation.

The float glass panes (A) and (C) have dimensions, as they are used, for example, for windshields, side windows, glass roofs, and rear windows in motor vehicle construction as well as for small, medium, or large area panes in the furniture, equipment, or construction sector. The dimensions can amount to several square centimeters to several square meters.

The polyvinyl butyral film (B1) is a common and known commercial product that can be obtained, e.g., from the company Sekisui Chemical or the company Solutia. It is the precursor of the intermediate layer (B).

The laminate according to FIG. 2 is produced in that the polyvinyl butyral film (B1) is cut to the necessary size, i.e., to the dimensions of the float glass panes (A) and (C). After that, the film (B1) is punched out in the appropriate shape and size at the location provided for the optical window (b2), with the opening (b22) resulting. Then, the precisely fitting insert (b21) is cut from a polyvinyl butyral film without infrared-radiation-screening effect and inserted into the opening (b22). This yields the intermediate layer (B).

Then, the two float glass panes (A) and (C) are firmly bonded to each other using a preliminary bonding method (calender rolling, spiral, or vacuum bag method) and an autoclave method through the intermediate layer (B) provided with the optical window (b2) such that the intermediate layer (B) is located between the two float glass panes (A) and (C) and forms the intermediate layer (B).

The laminate according to FIG. 1 is produced similarly, only a polyvinyl butyral film (B1) without an opening (b22) and insert (b21) is used.

1. An infrared-radiation-screening laminate transparent to visible light, stacked in a specified sequence comprising:
a first colorless, clear, transparent layer,
an intermediate layer transparent to visible light and with an infrared-radiation-screening effect on the first colorless, clear, transparent layer, the intermediate layer comprising:
i. at least one polyvinyl acetal resin as a layer-forming material; and
ii. at least one optical window permeable to at least infrared radiation; and
a second colorless, clear transparent layer on the intermediate layer.

2. The laminate according to claim 1, wherein the laminate has a g-value <75%, outside the optical window permeable to infrared radiation.

3. The laminate according to claim 1, wherein the optical window permeable to infrared radiation is free of infrared-radiation-screening effect and/or a tinting effect.

4. The laminate according to claim 1, wherein the intermediate layer has a tinting effect.

5. The laminate according to claim 1, wherein the infrared-radiation-screening effect is caused by an infrared-radiation-screening material and/or by an infrared-radiation-screening and a tinting material.

6. The laminate according to claim 4, wherein the tinting effect is caused by at least one material and/or at least another material.

7. The laminate according to claim 1, wherein the at least one optical window permeable to infrared radiation is formed by a precisely fitting insert, the precisely fitting insert being made substantially or entirely of polyvinyl acetal resin in an opening through the intermediate layer.

8. The laminate according to claim 1, wherein the optical window permeable to infrared radiation is free of tinting materials and/or infrared-radiation-screening materials and tinting materials.

9. The laminate according to claim 1, wherein the first colorless, clear, transparent layers and the second colorless, clear, transparent layer are made of at least one material that is selected from the group consisting of: glass and plastics.

10. The laminate according to claim 1, wherein the infrared screening material is selected from the group consisting one or more of: fine particulate metals, metal oxides, hydroxides, nitrides, oxynitrides, sulfides, phosphates, pyrophosphates, metaphosphates, polyphosphates, silicates, titanates, vanadates, molybdates, tungstates, fluorides, transparent electrically conductive oxides, TCO, and infrared-radiation-absorbing organic pigments and mixtures thereof.

11. The laminate according to claim 1, wherein the infrared-radiation-screening and tinting material is selected from the group consisting of: inorganic pigments, organic pigments, and dyes.

12. A method for manufacturing an infrared-radiation-screening laminate transparent to visible light, comprising:
providing a precursor of an intermediate layer transparent to visible light with an infrared-radiation-screening effect, comprising at least one polyvinyl acetal resin as a layer-forming material;
creating at least one optical window permeable to infrared radiation; and
bonding a resulting intermediate layer is firmly to at least one optical window permeable to infrared radiation with a first colorless, clear, transparent layer and a second colorless, clear, transparent layer, such that a laminate results,
wherein layers of the laminate are stacked in a sequence comprising: the first colorless, clear, transparent layer; an intermediate layer; and the second colorless, clear, transparent layer.

13. A method of manufacturing the laminate according to claim 1, comprising:
providing a precursor of an intermediate layer transparent to visible light with an infrared-radiation-screening effect comprising at least one polyvinyl acetal resin as a layer-forming material;
creating at least one optical window permeable to infrared radiation; and
bonding a resulting intermediate layer firmly to at least one optical window permeable to infrared radiation with a first colorless, clear, transparent layer and a second colorless, clear, transparent layer, such that a laminate results,
wherein layers of the laminate are stacked in a sequence comprising: the first colorless, clear, transparent layer; an intermediate layer; and the second colorless, clear, transparent layer.

14. The method according to claim 12, wherein the at least one optical window transparent to infrared radiation is produced by creating an opening in the precursor of the intermediate layer, into which a precisely fitting insert is inserted, wherein the precisely fitting insert that is free of an infrared-radiation-screening effect.

15. A method of using a colored, infrared-radiation-screening laminate transparent to visible light according to claim 1, in a means of land transportation, a means of water transportation, a means of air traffic, in a furniture sector, an equipment sector, or a construction sector.

16. A method of using a colored, infrared-radiation-screening laminate transparent to visible light, manufactured according to claim 12, in a means of land transportation, a means of water transportation, a means of air traffic, in a furniture sector, an equipment, or a construction sector.

17. The laminate according to claim 1, wherein the laminate has a g-value <64% outside the optical window permeable to infrared radiation.

18. The laminate according to claim 1, wherein the infrared-radiation-screening and tinting material selected from the group consisting of: iron oxide pigments, iron sulfide pigments, iron-containing pigments and chromium-containing pigments.

19. The method according to claim 13, wherein the at least one optical window transparent to infrared radiation is produced by creating an opening in the precursor of the intermediate layer, into which a precisely fitting insert is inserted, wherein the precisely fitting insert that is free of an infrared-radiation-screening effect.
